(19) United States
(12) Patent Application Publication
(10) Pub. No.: US 2006/0168743 A1
(43) Pub. Date: Aug. 3, 2006

(54) Motorized hand washing device

(76) Inventor: Ronald E. Homer, Winter Park, FL (US)

Correspondence Address: EDWARD M. LIVINGSTON, PA, 963 TRAIL TERRACE DRIVE, NAPLES, FL, 34103, US

(21) Appl. No.: 11/048,491

(22) Filed: Feb. 1, 2005

(51) Int. Cl. B08B 1/04

(52) U.S. Cl. 15/21.1

(57) ABSTRACT

A motorized hand washing device (1) having a body (2), a plurality of brushes (4), preferably having nylon bristles, connected to gears (8) and a centralized motor (3). A center shaft (11) is connected to the motor (3) on one end and to the gears (8) on the other. The gears (8), which have individual shafts (7) for the movement of each brush (4), allows for the movement of the brushes (4) in a circular motion when a user presses his or her hand on the brushes (4). Optional means for fastening the device to surfaces, such as the preferable use of suction cups (9), allow for the easy transportability and adaptability of the present invention in schools, work environments, bathrooms, kitchens, garages or anyplace where hand cleanliness is of importance.

### BACKGROUND OF THE INVENTION

This invention relates to hand washing devices, more particularly, a pressure activated motorized hand washing device.

Hand washing has consistently been proven the number one deterrent for contracting colds, flus and other bacterial/viral infections. According to the United States Center for Disease Control (the CDC), the single most important thing a person can do to keep from getting sick and spreading sickness to others is to wash his or her hands. However, many individuals still fail to properly wash his or her hands with soap and warm water for the recommended 15 to 20 seconds or even make an attempt to wash his or her hands at all. The resulting outcome is widespread sickness that is easily preventable.

The excuses for lack of hand washing range from not having enough time to wash to believing that you contract more germs when touching a water faucet while washing to simply forgetting to wash. The most notorious non-hand washers are children, who simply dislike the act of washing their hands. The resulting outcome is the widespread transmittal of germs and diseases in schools. In fact, more than 22 million school days are lost annually due to the common cold alone (CDC, 1996).

Alternatively, many individuals attempt to wash his or her hands thoroughly but find it difficult to remove the dirt and grime on the hands. Mechanics, landscapers and other individuals who work with grease and grime on a daily basis find it takes several minutes to scrub the dirt and grime off his or her hands. Even after a thorough cleaning, however, many find that remnants of dirt/grease/grime remain on the hands, underneath the fingernails or in the nail beds. Rather than going back to the sink to scrub again, many simply accept the dirt/grease/grime on the hands as simply an unavoidable consequence of their job.

Currently, there are motorized hand washing devices designed to clean one's hands. However, the current devices are cumbersome, inefficient, difficult to operate and simply unattractive in appearance.

Thus, a need exists for a motorized hand washing device that is a fun, easy-to-operate and which thoroughly cleans hands so as to promote hand washing.

The relevant prior art includes the following patents:

| Pat. No. | | |
|---|---|---|
| (U.S. unless stated otherwise) | Inventor | Issue/Publication Date |
| 5,379,474 | Nakamura | Jan. 10, 1995 |
| 4,052,766 | Morrison | Oct. 11, 1977 |
| 5,345,640 | Goss | Sep. 13, 1994 |
| 1,366,306 | Wick | Jan. 18, 1921 |
| 4,800,606 | Kolesky | Jan. 31, 1989 |
| 4,180,884 | Hess et al. | Jan. 01, 1980 |
| 4,130,908 | Alcamo | Dec. 26, 1978 |
| 3,940,819 | McMackin et al. | Mar. 02, 1976 |

### SUMMARY OF THE INVENTION

The primary object of the present invention is to provide a motorized hand washing device that is pressure-activated.

A further object of the present invention is to provide a motorized hand washing device that thoroughly cleans one's hands.

An even further object of the present invention is to provide a motorized hand washing device that is easy to use.

A further object of the present invention is to provide a motorized hand washing device that is attractive.

An even further object of the present invention is to provide a motorized hand washing device that is battery-operated.

An even further object of the present invention is to provide a motorized hand washing device that is sanitary.

Another object of the present invention is to provide a motorized hand washing device that is securable to almost any surface.

The present invention fulfills the above and other objects by providing a motorized hand washing device comprised of a plurality of scrub brushes located on a brush pad, a preferably plastic body having a lip and a base housing and gears which move the brushes when a motor is operating.

To use the present invention, a person adds water to the body so the water line is above the brushes. Then, a person may add either a liquid soap or use a bar soap to create soapy water. A person then inserts his or her hand into the water, positions the hand on the brushes and presses down on the brushes to activate the device for hand cleansing. When finished, the person may remove the lip from the base of the body and change the brush pad.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a side cut-away view of the present invention;

FIG. 2 is a top view of the embodiment of FIG. 1;

FIG. 3 is a cross-sectional view along line 3-3 of the embodiment of FIG. 1;

FIG. 4 is a perspective view of the present invention in use;

FIG. 5 is a perspective view of the lip of the present invention;

FIG. 6 is a perspective view of the base of the present invention; and

FIG. 7 is a perspective view of the brush pad of the present invention.

### DESCRIPTION OF THE PREFERRED EMBODIMENTS

For purposes of describing the preferred embodiment, the terminology used in reference to the numbered components in the drawings is as follows:
1. motorized hand washing device, generally
2. body
3. motor
4. brush
5. brush pad
6. soapy water
7. shaft
8. gear
9. suction cup
10. battery
11. center shaft
12. power switch
13. hand
14. battery housing
15. optional speed switch
16. lip
17. base housing
18. slots
19. rigid layer
20. brush pad bottom

With reference to FIG. 1, a side cut-away view of the present invention is shown. The motorized hand washing device 1 comprises a body 2, which is preferably plastic, having a base housing 17 and a lip 16, a plurality of brushes 4, which preferably have nylon bristles, operatingly connected to gears 8 and a centralized motor 3 to operate the device 1. A center shaft 11 is connected to the motor 3 on one end and to the gears 8 on the other. The gears 8, which have individual shafts 7 for the movement of each brush 4, allow for the movement of the brushes 4 in a circular motion. The gears 8 are sandwiched in between a rigid layer 19, preferably plastic, and the brush pad bottom 20 so as to keep the gears 8 in place. The center shaft 11 allows for the movement of the brush pad 5 in a revolving motion. Thus, both the brushes 4 and the brush pad 5 move in circular directions to provide for thorough hand cleansing. Optional means for fastening the device to surfaces, such as the preferable use of suction cups 9, allow for the easy transportability and adaptability of the present invention in schools, work environments, bathrooms, kitchens, garages or anyplace where hand cleanliness is of importance.

While the base 17 houses the motor 3, battery housing 14 and batteries 10 within the housing 10, it also hosts the gears 8, the brush pad 5, the center shaft 11 and the shafts 7. On the other hand, the lip 16 simply acts as a wall to maintain the soapy water 6 within the device 1.

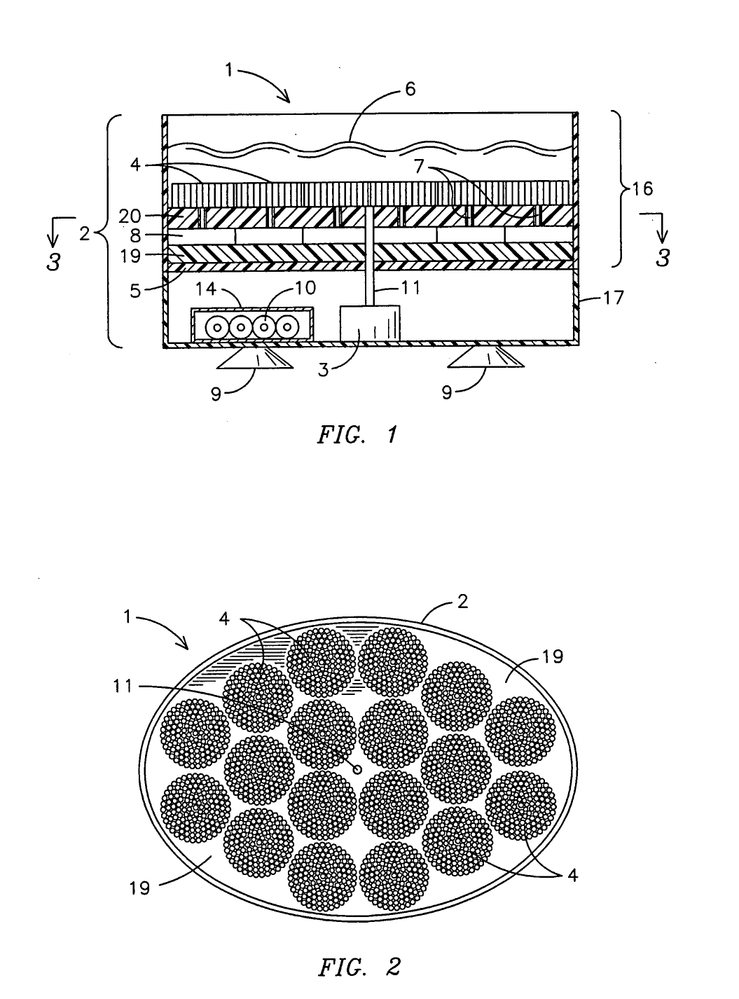

In FIG. 2, a top view of the embodiment of FIG. 1 is shown. The brushes 4 are preferably round in shape and are confined within the body 2. Although a user may see the central gasket 11, the central gasket 11 is not raised so as to be within the brushes 4, but rather rises only to the base of the brushes 4 so as not to injure a person using the device 1.

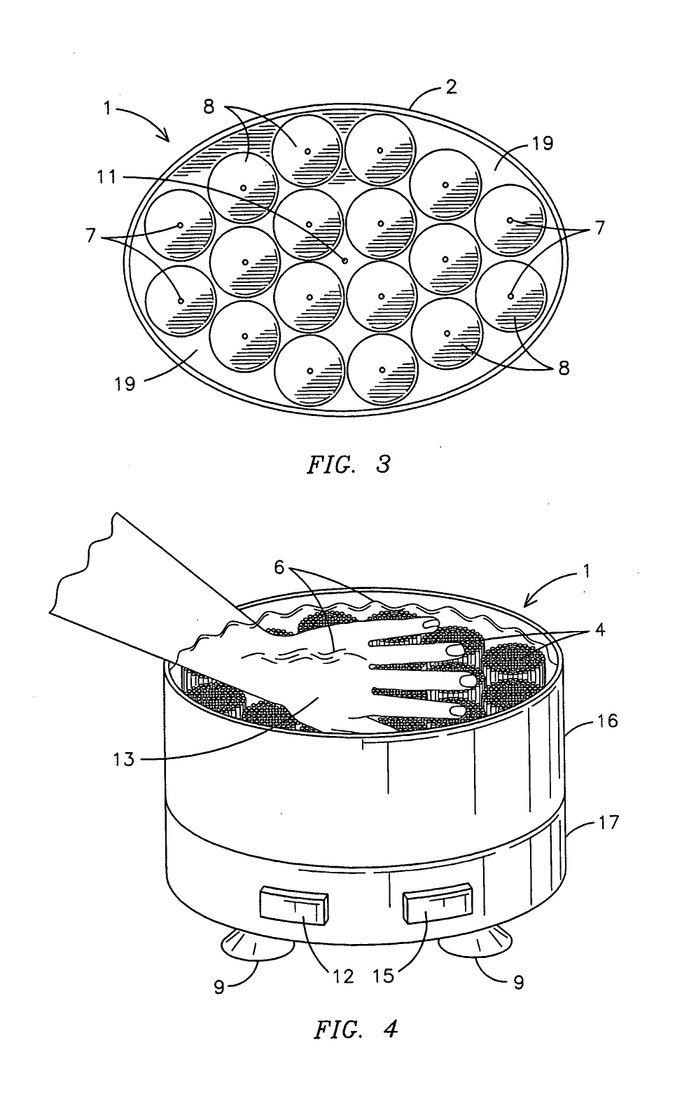

FIG. 3 shows a cross-sectional view along line 3-3 of the embodiment of FIG. 1. The gears 8 of the present invention are preferably sized and shaped according to the corresponding brush 4. Thus, because the brushes 4 are pictured round, the corresponding gears 8 are also round. However, the gears 8 need not be limited to round shapes but may be of any shape and may also not correspond to the shape of the brushes 4. Each gear 8 has a shaft 7 located in its center.

In FIG. 4, a perspective view of the present invention in use is shown. If the device is in an “OFF” position, he or she simply turns the power switch 12 to the “ON” position. Then, he or she simply places his or her hand 13 into the device 1 filled with soapy water 6. and presses down on the brushes 4 to activate the washing process. The person may adjust the speed of the device 1 by pressing the optional speed switch 15.

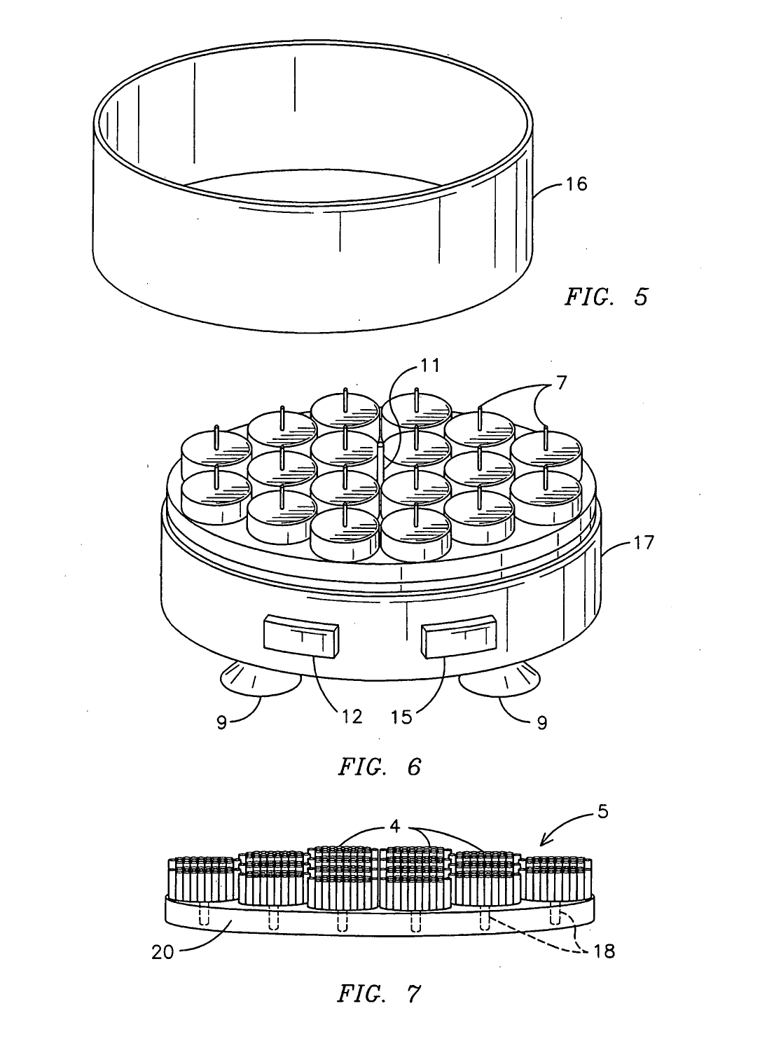

With reference to FIGS. 5 and 6, perspective views of the lip 16 and base 17 of the present invention are shown. The lip 16 is preferably round in shape and is sized so as to attach to the base 17.

Finally, FIG. 7 is a perspective view of the brush pad 5 of the present invention. The brush pad 5 has a bottom layer 20 which is preferably plastic. The layer 20 acts to hold the gears 8 in place while also forming the bottom of the brush pad 5. The brushes 4 are located on the brush pad 5 and slots 18 are located on the bottom layer 20 of the brush pad 5 for the acceptance of the shafts 7. For sanitary and effectiveness measures, the brush pad 5 is removable and replaceable.

In addition, the present invention maybe manufactured in a variety of shapes, sizes and colors to accommodate users having differing hand sizes or differing personal tastes. Furthermore, although the invention is taught with the use of batteries 10, the present invention may also be used with a traditional electrical cord and electrical socket method (not shown).

The use of the present invention will allow a person to thoroughly clean his or her hands in a fun and unconventional method.

It is to be understood that while a preferred embodiment of the invention is illustrated, it is not to be limited to the specific form or arrangement of parts herein described and shown. It will be apparent to those skilled in the art that various changes may be made without departing from the scope of the invention and the invention is not be considered limited to what is shown and described in the specification and drawings.

Having thus described my invention, I claim:

1. A motorized hand washing device comprising:
a substantially rigid body having a lip and a base housing;
said base housing having a motor electrically connected to a power source;
said motor being operatively connected to at least one gear; and
wherein at least one brush operatively connected to said at least one gear wherein said at least one brush rotates when pressure is applied thereon.

2. The motorized hand washing device of claim 1 further comprising:
a means for securing said body to a surface.

3. The motorize hand washing device of claim 1 wherein:
said power source is at least one battery.

4. The motorized hand washing device of claim 1 wherein:
said power source is an AC electric source.

5. The motorized hand washing device of claim 1 wherein:
said motor is electrically connected to an external power switch.

6. The motorized hand washing device of claim 3 wherein:
said motor is electrically connected to an external power switch.

7. The motorized hand washing device of claim 4 wherein:
said motor is electrically connected to an external power switch.

8. The motorized hand washing device of claim 1 further comprising:
a rotatable center shaft connected to said motor.

9. The motorized hand washing device of claim 8 wherein:
a brush pad is rotated when said center shaft rotates.

10. The motorized hand washing device of claim 9 wherein:
said brush pad includes a plurality of brushes.

11. The motorized hand washing device of claim 8 wherein:
said rotatable center shaft is connected to a plurality of gears.

12. The motorized hand washing device of claim 11 wherein:
said plurality of gears are operatively connected with a plurality of brushes.

13. The motorized hand washing device of claim 1 wherein:
said motor is electrically connected to an external speed switch.

14. The motorized hand washing device of claim 1 wherein:
said connection between said motor and said at least one gear is via a center shaft.

15. The motorized hand washing device of claim 2 wherein:
said means for securing said body to a surface is via suction cups.

16. A motorized hand washing device comprising:
a substantially rigid body having a lip and a base housing;
said base housing having a motor electrically connected to at least one battery located within said base housing;
said motor electrically connected to an external power switch and an external speed switch;
said base housing having a plurality of shafts;
said motor being operatively connected to a center shaft;
said center shaft operatively connected with a plurality of gears;
said plurality of gears being operatively connected with said plurality of shafts;
a brush pad having a bottom and a plurality of brushes attached to said bottom;
said brush pad having a plurality of slots located on said bottom sized to accommodate said plurality of shafts; and
wherein said plurality of brushes and said brush pad rotate when pressure is applied on said plurality of brushes.

17. A method of using a motorized hand washing device comprising a substantially rigid body having a lip and a base housing; said base housing having a motor electrically connected to a power source; said motor being operatively connected to at least one gear; and wherein at least one brush operatively connected to said at least one gear wherein said at least one brush rotates when pressure is applied thereon, said method comprising the steps of:
a. pouring water into said body;
b. adding soap to said water to create soapy water;
c. submersing a hand into said soapy water; and
d. pressing down on said at least one brush to activate said motorized hand washing device.
